(19) United States
(12) Patent Application Publication
(10) Pub. No.: US 2005/0097127 A1
(43) Pub. Date: May 5, 2005

(54) Reordering data between a first predefined order and a second predefined order with secondary hardware

(75) Inventor: Michael P. Foley, Berkeley, CA (US)

Correspondence Address: MICROSOFT CORPORATION;LAW OFFICES OF RONALD M. ANDERSON, 600 108TH AVENUE N.E., SUITE 507, BELLEVUE, WA, 98004, US

(73) Assignee: Microsoft Corporation, Redmond, WA (US)

(21) Appl. No.: 10/697,420

(22) Filed: Oct. 30, 2003

(51) Int. Cl. G06F 17/00

(52) U.S. Cl. 707/103 Y

(57) ABSTRACT

Offloading the reordering of data between a first predefined order and a second predefined order by causing a secondary processor to perform an operation that was originally intended for another function, such as rendering a geometric shape. Pixels of image data are thus reordered from pixilated little endian order to big endian order with standardized textured draw operations performed by a graphics coprocessor. Preferably, only data that changed from a previous processing cycle are reordered. Subdivisions of the data are determined as a function of a predefined datum size. Further subsets of each subdivision can also be determined with a predefined mask, so that reordering can be applied to multiple subsets at a time. Coordinates of each subdivision are used as input to the secondary processor operation, which transforms the position of each datum so as to reorder the data between the first predefined order and the second predefined order.

### FIELD OF THE INVENTION

The present invention generally relates to a method and system to offload reordering of data to a secondary processor, and more specifically, pertains to reordering data between a first predefined order and a second predefined order with secondary hardware utilizing conventional functions not defined to reorder the data between the first predefined order and the second predefined order.

### BACKGROUND OF THE INVENTION

When a computer reads from or writes to sequential memory, the ordering of the data bytes typically occurs in one of two ways. One way is called the big endian method and the other way is called the little endian method. The big endian method stores the most significant byte first. For example, a 32-bit hexadecimal value 0x12345678 would be written as four 8-bit bytes of data in the following order, 0x12, 0x34, 0x56, 0x78. The big endian method is often used in computers that include MOTOROLA™ processors. Conversely, the little endian method stores the least significant byte first. For instance, the 32-bit hexadecimal value 0x12345678 above would be written in reverse byte-wise order 0x78, 0x56, 0x34, 0x12. The little endian method is often used in computers that include INTEL™ x86 processors.

Some hybrid processors are bi-endian, meaning that the processor can be switched to work in big endian mode or little endian mode. The POWERPC™ processor developed by Motorola, Inc., International Business Machines, Inc. (IBM), and Apple Computer, Inc. is a bi-endian processor. The POWERPC generally runs in big endian mode, but includes a little endian mode that enables the POWERPC to run some software that was designed for little endian processors. For example, an emulation program, such as VIRTUAL PC FOR MAC™ marketed by Microsoft Corporation, uses the little endian mode of the POWERPC to simplify emulation of the INTEL x86 instruction set and to access memory in little endian format.

Accessing memory in the little endian mode involves an addressing operation by the POWERPC, because data are actually stored in big endian order in physical memory. To ensure that data are communicated correctly between physical memory and the emulation program, one of the following addressing operations is applied by the POWERPC:
For 8-bit accesses in little endian mode, the address of the access is bit-wise exclusive OR-ed with 0x00000007. A write of 8 8-bit values, 0x00, 0x1, 0x22, 0x33, 0x44, 0x55, 0x66, 0x77, would be stored in memory as 0x77, 0x66, 0x55, 0x44, 0x33, 0x22, 0x11, 0x00.
For 16-bit aligned 16-bit accesses in little endian mode, the address of the access is bit-wise exclusive OR-ed with 0x00000006. A write of four 16-bit values, 0x0011, 0x2233, 0x4455, 0x6677, would be stored in memory as 0x66, 0x77, 0x44, 0x55, 0x22, 0x33, 0x00, 0x11.
For 32-bit aligned 32-bit accesses in little endian mode, the address of the access is bit-wise exclusive OR-ed with 0x00000004. A write of two 32-bit values, 0x0012233, 0x44556677, would be stored in memory as 0x44, 0x55, 0x66, 0x77, 0x00, 0x11, 0x22, 0x33.
Aligned 64-bit accesses are not modified.
Non-aligned, multi-byte accesses in little endian mode are corrected in hardware by G3 and G4 processors.
   The above addressing operations illustrate that the little endian mode of the POWERPC generates a physical storage order that is not necessarily a pure little endian order, since the ordering is not always broken down to 8-bit bytes to ensure that the least significant byte appears first. In cases that are not pure little endian order, such as the graphics examples discussed below, the POWERPC's little endian mode storage order will be referred to as a pixilated little endian order. Conversely, a variant order wherein the data are stored in little endian order, but are subject to a similar addressing operation, can be referred to as a pixilated big endian order. Additional details regarding the addressing operations and other aspects of the POWERPC are described in “PowerPC Microprocessor Family: The Programming Environments for 32-Bit Processors” (IBM publication #G522-0290-01, Feb. 21, 2000).

The appropriate little endian addressing operation is applied when display image data for the emulation program are created and stored in emulation program video random access memory (VRAM) (i.e., VRAM allocated for the emulation program). To actually display the display image data on a screen, the display image data must be transferred from the emulation program VRAM to the screen. However, the interface that transfers display image data to the screen runs in big endian mode. Thus, to correctly display the data, the emulation program reorders the display image data while copying the display image data from the emulation program VRAM to a screen buffer. The operating system then copies the data from the screen buffer to the screen.

Unfortunately, this reordering step consumes processor time. It would be desirable to offload this reordering to a secondary processor, rather than consume the main processor's time. It would also be desirable to utilize conventional functions of secondary processors to accomplish the reordering, rather than require specialized code that is dedicated only to reordering.

### SUMMARY OF THE INVENTION

The present invention is directed to a method and system for offloading the reordering of data between a first predefined order and a second predefined order by causing a secondary processor to perform an operation that is not intended for reordering the data between the predefined orders. Instead, the operation is intended to perform another function such as rendering a geometric shape with a selected texture applied. However, by subdividing the data as a function of a predefined size of each datum of the data, the operation transforms the position of each datum so as to reorder the data between the first predefined order and the second predefined order. For example, image data arranged in pixilated little endian order can be subdivided as a function of pixel size, and the pixels can be repositioned into big endian order with standardized textured draw operations performed by a graphics coprocessor.

In further detail, the secondary processor accesses the data that are arranged in the first predefined order. Preferably, the data are stored in a predefined secondary storage space after having been copied directly from a primary storage space. For efficiency, only that portion of the data that changed since a previous processing cycle can be copied and reordered. The predefined size of each datum is used to determine subdivisions that each comprise a subset of data, such as a rectangular subset of image data, that can be transformed with the secondary processor operation to reorder each subdivision of the data. In an alternative preferred embodiment, the data are further subdivided with a predefined mask into additional subsets of data, such as columns of pixel data. This step enables each corresponding subset of each subdivision to be operated on at the same time, thereby requiring fewer total operations.

For iteration purposes, the size of each subdivision and the number of subdivisions within the data are also determined. Coordinates of each subdivision are determined and used as input parameters by the secondary processor to perform the standardized operation on each subdivision. For instance, the coordinates can correspond to vertices of a geometric shape representative of each subdivision relative to an origin corresponding to an initial memory address of the data. The standardized operation transforms the coordinates to new coordinate positions and repositions the subset of data to maintain the same relative position with respect to the new coordinate positions as the subset of data had with respect to the original coordinates. The repositioning preferably corresponds to reversing, mirroring, or otherwise symmetrically transforming the data. Thus, the repositioning of the subset of data reorders the data to the second predefined order.

Another aspect of the present invention is directed to a memory medium storing machine instructions that cause the secondary processor to relieve the primary processor from performing most of the steps described above as discussed in further detail below.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a functional block diagram illustrating an exemplary computing system for use with the present invention and includes a general purpose computing device in the form of a conventional personal computer (PC), such as a MACINTOSH™ PC produced by Apple Computer, Inc.;

FIG. 2 is a flow diagram illustrating logic for a first preferred method of offloading the reordering of pixel data;

FIG. 3 is a graphical example of the logic illustrated by FIG. 2;

FIG. 4 is a flow diagram illustrating logic of a second preferred embodiment for offloading the reordering of out-of-order data; and

FIG. 5 is a graphical example of the logic illustrated by FIG. 4.

### DESCRIPTION OF THE PREFERRED EMBODIMENT

Computing Environment

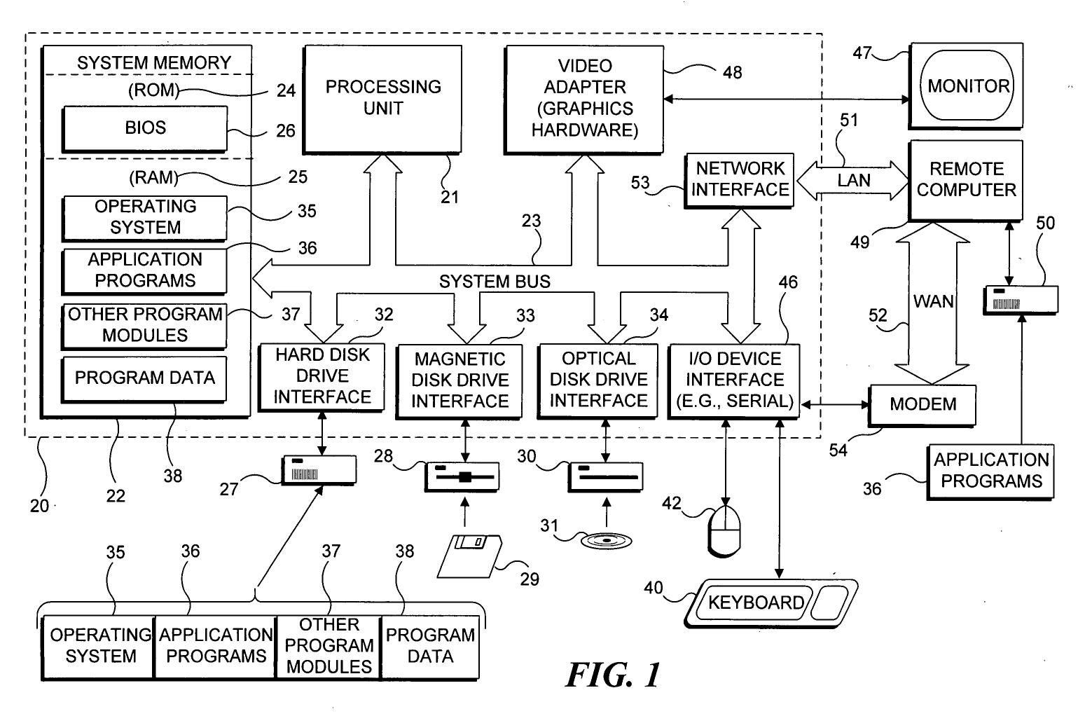

FIG. 1 and the following discussion are intended to provide a brief, general description of a suitable computing environment in which the present invention may be implemented. Although not required, the present invention will be described in the general context of computer executable instructions, such as program modules, which are executed by a PC. Generally, program modules include routines, programs, objects, components, data structures, etc. that perform particular tasks or implement particular abstract data types. A preferred embodiment is described below in the context of an emulation program executed on a MACINTOSH PC, such as Microsoft Corporation's VIRTUAL PC FOR MAC, which enables software that was designed for little endian processors to run on a MACINTOSH PC produced by Apple Computer, Inc. However, those skilled in the art will appreciate that the present invention may be practiced with other programs and computing platforms that require reordering of data. Those skilled in the art will also appreciate that the present invention may be practiced with other computer system configurations, including hand held devices, multiprocessor systems, microprocessor based or programmable consumer electronic devices, network PCs, minicomputers, mainframe computers, and the like. The present invention may also be practiced in distributed computing environments, where tasks are performed by remote processing devices that are linked through a communications network. In a distributed computing environment, program modules may be located in both local and remote memory storage devices.

With reference to FIG. 1, an exemplary system for implementing the present invention includes a general purpose computing device in the form of a conventional personal computer 20 (e.g., a MACINTOSH PC), provided with a primary processing unit 21 (e.g., a POWERPC processor), a system memory 22, and a system bus 23. The system bus couples various system components, including the system memory, to processing unit 21 and may be any of several types of bus structures, including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that helps to transfer information between elements within personal computer 20, such as during start up, is stored in ROM 24. Personal computer 20 further includes a hard disk drive 27 for reading from and writing to a hard disk, not shown, a magnetic disk drive 28 for reading from or writing to a removable magnetic disk 29, and an optical disc drive 30 for reading from or writing to a removable optical disc 31, such as a CDROM or other optical media. Hard disk drive 27, magnetic disk drive 28, and optical disc drive 30 are connected to system bus 23 by a hard disk drive interface 32, a magnetic disk drive interface 33, and an optical disc drive interface 34, respectively. The drives and their associated computer readable media provide nonvolatile storage of computer readable machine instructions, data structures, program modules and other data for personal computer 20. Although the exemplary environment described herein employs a hard disk, removable magnetic disk 29, and removable optical disc 31, it will be appreciated by those skilled in the art that other types of computer readable media, which can store data that are accessible by a computer, such as magnetic cassettes, flash memory cards, digital video disks, Bernoulli cartridges, random access memories (RAMs), read only memories (ROM), and the like, may also be used in the exemplary operating environment.

A number of program modules may be stored on the hard disk, magnetic disk 29, optical disc 31, ROM 24 or RAM 25, including an operating system 35, one or more application programs 36, other program modules 37, and program data 38. A user may enter commands and information into personal computer 20 through input devices such as a keyboard 40 and a pointing device 42. Other input devices (not shown) may include a microphone, joystick, game pad, satellite dish, scanner, or the like. These and other input devices are often connected to processing unit 21 through an input/output (I/O) interface 46 that is coupled to the system bus. The term I/O interface is intended to encompass each interface specifically used for a serial port, a parallel port, a game port, a keyboard port, and/or a universal serial bus (JSB). A monitor 47 or other type of display device is also connected to system bus 23 via an appropriate interface, such as a video adapter 48 that comprises graphics hardware, including a graphics processing unit (GPU) and VRAM. In addition to the monitor, personal computers are often coupled to other peripheral output devices (not shown), such as speakers (through a sound card or other audio interface—not shown) and printers.

Personal computer 20 may operate in a networked environment using logical connections to one or more remote computers, such as a remote computer 49. Remote computer 49 may be another personal computer, a server, a router, a network personal computer, a peer device, or other common network node, and typically includes many or all of the elements described above in connection with personal computer 20, although only an external memory storage device 50 has been illustrated in FIG. 1. The logical connections depicted in FIG. 1 include a local area network (LAN) 51 and a wide area network (WAN) 52. Such networking environments are common in offices, enterprise wide computer networks, intranets and the Internet.

When used in a LAN networking environment, personal computer 20 is connected to LAN 51 through a network interface or adapter 53. When used in a WAN networking environment, personal computer 20 typically includes a modem 54, or other means for establishing communications over WAN 52, such as the Internet. Modem 54, which may be internal or external, is connected to the system bus 23, or coupled to the bus via I/O device interface 46, i.e., through a serial port. In a networked environment, program modules depicted relative to personal computer 20, or portions thereof, may be stored in the remote memory storage device. It will be appreciated that the network connections shown are exemplary and other means of establishing a communications link between the computers may be used.

First Preferred Embodiment

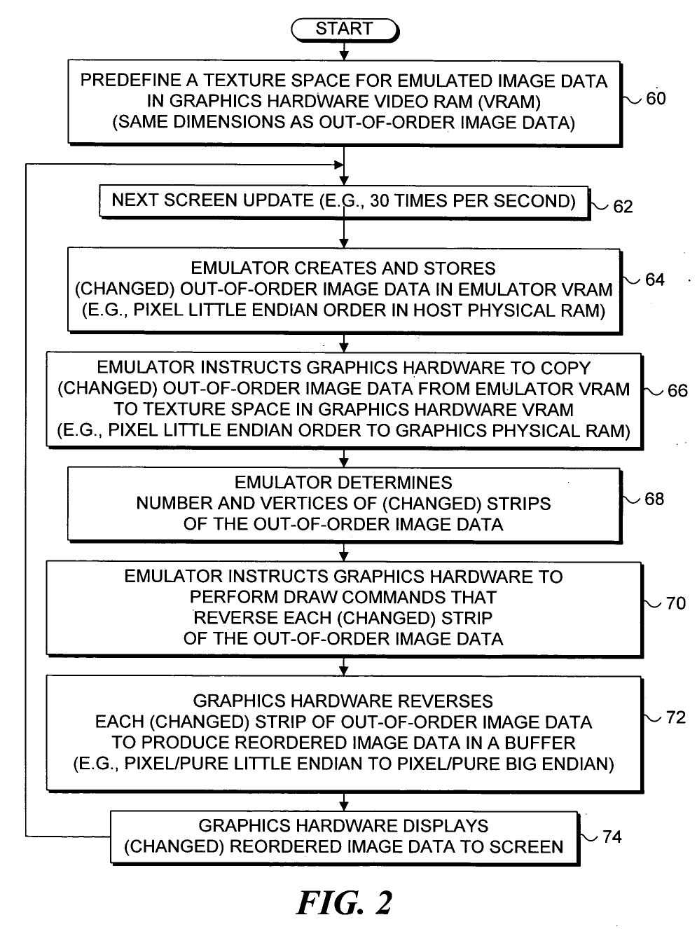

FIG. 2 is a flow diagram illustrating logic for a first preferred method of offloading the reordering of pixel data. At a step 60, a control program, such as a virtual PC emulator, predefines a texture space in graphics hardware VRAM to hold image data produced by the emulator. The texture space is predefined with dimensions equal to those of the emulator's video buffer within the emulator VRAM that is used to store newly generated out-of-order image data. In the exemplary embodiments discussed herein, the emulator VRAM preferably corresponds to the PC's primary physical RAM. At a step 62, a timing event occurs to initiate a next screen update. For example, a refresh timer may trigger a screen update every 33 milliseconds, corresponding to 30 refreshes per second. At a step 64, the emulator creates and stores out-of-order image data in the emulator's VRAM. The out-of-order image data are arranged in a pixelated little endian order. True little endian order stores individual bytes in a reversed order, but does not reorder full pixels. However, this exemplary embodiment is based on the POWERPC's emulated little endian mode. Thus, for the preferred embodiments discussed herein, the pixels are arranged in little endian order, rather than just the individual bytes of each pixel being stored in true little endian order. Those skilled in the art will recognize that the present invention can be applied to any level or grouping of out-of-order data that can be offloaded for processing by a secondary processor such as a graphics processor.

When creating and/or storing out-of-order image data, the emulator can also track the pixel data that have changed from frame to frame. Tracking the changed pixel data enables the emulator to minimize the amount of image data that must be reordered. Specifically, the emulator need only reorder and refresh image data in that portion of the emulated screen that has changed since the previous frame was rendered. Thus, at step 64, the emulator need only create and/or store changed out-of-order image data in the emulator's VRAM.

After the emulator creates the out-of-order image data via the POWERPC and stores the out-of-order image data in the emulator's VRAM, the emulator instructs graphics hardware to copy the full or changed out-of-order image data from the emulator VRAM to the texture space in the graphics hardware VRAM, at a step 66. This is a true copy from the PC's primary physical RAM to the graphics hardware physical RAM, so that the out-of-order image data remain out-of-order once copied to the graphics hardware VRAM.

At a step 68, the emulator determines the number of, and the vertices of, full or changed strips of the out-of-order image data. A strip of out-of-order image data is simply a rectangular subdivision of pixels. The width of the strips depends on the bit size of the corresponding pixels. For example, 8-bit pixels correspond to strips that are each 8 pixels wide. Alternatively, 16-bit pixels correspond to strips that are each 4 pixels wide. Similarly, 32-bit pixels correspond to strips that are each 2 pixels wide. Thus, the number of strips depends on the size of the pixels and an overall width of a window area used by the emulator to display image data. The vertices of each strip are determined relative to the boundaries of the window area. As discussed above, the width of each strip is determined by the size of the pixels, and the strips do not overlap. However, the top and bottom edges of the strips simply correspond to the top and bottom edges of the emulator window image area.

At a step 70, the emulator instructs the graphics hardware to perform texture draw commands that reverse each full or changed strip of the out-of-order image data. The draw commands preferably correspond to conventional OpenGL functions such as glTexCoord and glVertex functions. Sample code of these draw commands and other emulator instructions described above is provided in Appendix A.

At a step 72, the graphics hardware performs the draw operations, thereby reversing each full or changed strip of the out-of-order image data to produce reordered image data in a buffer, such as a screen buffer. The effect is to change the image data from pixelated little endian order to big endian order. At a step 74, the graphics hardware then displays the full or changed reordered image data on the screen. Those skilled in the art will recognize that slight modification to the above steps enables reordering between pure little endian order and big endian order. For example, each pixel of the pixilated little endian data can be treated like a mini-strip. Each grouping of bytes within a pixel can be reversed in the mini-strip. When each grouping is reversed, the data is in pure little endian order whereby the least significant byte appears first in the number. Conversely, data in a pure or pixilated big endian order can be reordered into a pure or pixilated little endian order by the opposite reversing.

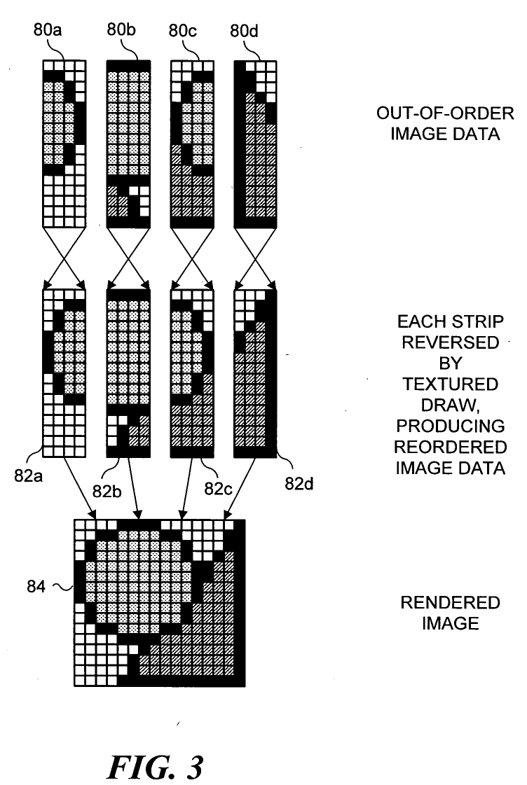

FIG. 3 is a graphical example of the logic illustrated by FIG. 2. The emulator creates and stores the out-of-order image data in subdivisions illustrated by strips 80a through 80d. In this graphical example, each pixel comprises 16 bits (i.e., 2 bytes), which results in 4 strips that are each 4 pixels wide. Strips 80a through 80d illustrate the pixelated little endian order discussed above, wherein the pixels are out of order rather than the data defining each individual pixel being out of order. This pixilated little endian order results in pixels that are backwards within each strip. After the out-of-order image data are copied to the texture space in the graphics hardware VRAM, the emulator determines source coordinates of the vertices of each strip. The emulator then instructs the graphics hardware to perform textured draw commands that specify new destination positions for the coordinates. Table 1 illustrates sample source coordinates and destination positions relative to an origin defined as the upper left corner of the emulator window area. The coordinates are listed as top, left, bottom, and right.

TABLE 1
Sample Source Coordinates and Destination Positions

| Source Coordinates | Destination Positions |
|---|---|
| (top, left, bottom, right) | (top, left, bottom, right) |
| 0, 4, 16, 0 | 0, 0, 16, 4 |
| 0, 8, 16, 4 | 0, 4, 16, 8 |
| 0, 12, 16, 8 | 0, 8, 16, 12 |
| 0, 16, 16, 12 | 0, 12, 16, 16 |

The textured draw commands reverse each strip of out-of-order image data to produce reordered strips 82a through 82d. Reordered strips 82a through 82d are consequently in big endian order. The graphics hardware then displays the reordered image data on the screen, producing a rendered image 84. Those skilled in the art will recognize how the process described above can readily be modified to reorder the image data from big endian order to little endian order.

Second Preferred Embodiment

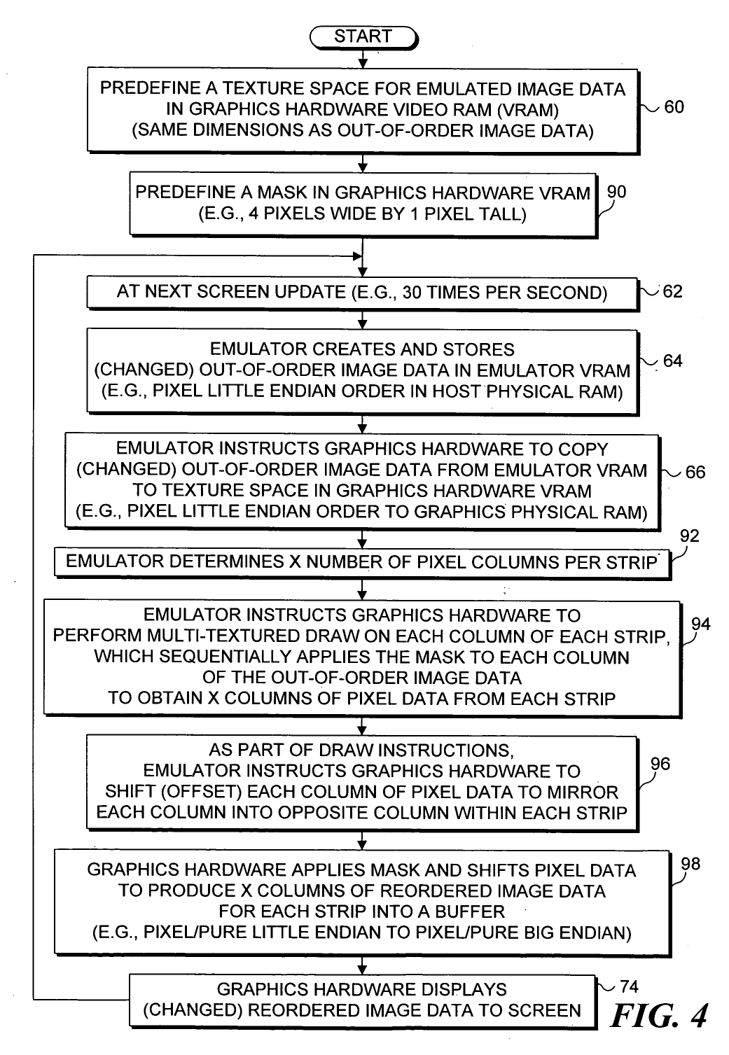

FIG. 4 is a flow diagram illustrating logic of a second preferred embodiment for offloading the reordering of out-of-order data. As with the first preferred embodiment, the emulator predefines a texture space at step 60 to store emulated image data in the graphics hardware VRAM. In this second preferred embodiment, the emulator also predefines a mask in the graphics hardware VRAM at a step 90. The mask will be used to further subdivide portions of the out-of-order image data into subsets during processing by the graphics hardware. The mask size is relative to the data size of each pixel of out-of-order image data. For example, if each pixel comprises 8 bits, the mask will be 8 pixels wide by 1 pixel tall. Alternatively, if each pixel comprises 16 bits, the mask will be 4 pixels wide by 1 pixel tall. Similarly, if each pixel comprises 32 bits, the mask will be 2 pixels wide by 1 pixel tall. In each case, the alpha parameter of the left-most pixel of the mask is set to 1 (opaque), and the remaining pixels are set to 0 (transparent). During processing, the mask will be iteratively applied to the out-of-order image data to sequentially select subset columns of pixels of the out-of-order image data, as described in further detail below.

When a screen update event is detected at step 62, the emulator creates and stores full or changed out-of-order image data in the emulator VRAM at step 64. At step 66, the emulator then instructs the graphics hardware to copy the full or changed out-of-order image data from the emulator VRAM to the texture space in the graphics hardware VRAM. At a step 92, the emulator determines a number of pixel columns to be used for each strip of image data. As discussed above, the number of pixel columns will depend on the number of bits per pixel. For example, if each pixel comprises 16 bits (i.e., 2 bytes), then each strip will comprise four columns of pixels.

At a step 94, the emulator instructs the graphics hardware to perform a multi-textured draw on each strip of out-of-order image data. This multi-textured draw iteratively applies the mask to each row of out-of-order image data in each strip. The opaque pixel of the mask is also sequentially shifted to each position in the mask, so that the multi-textured draw creates individual columns of pixels from each strip of the out-of-order image data. Also as part of the multi-textured draw, the graphics hardware is instructed to shift each corresponding column of pixel data within each strip, at a step 96. Each multi-textured draw will thus shift a column in each strip, thereby reducing the number of draw operations that must be performed. The columns will be shifted to mirror opposite positions within each strip. Having received the instructions from the emulator, the graphics hardware applies the mask and shifts the pixel data to produce the appropriate number of columns of reordered image data, at a step 98. Each strip is thereby transformed from pixelated little endian order to big endian order. Preferably, the reordered image data are written to a screen buffer from which the graphics hardware displays the full or changed reordered image data to the screen, at step 74. Sample code for implementing the above steps is provided in Appendix B. The sample code uses standard OpenGL functions to implement the multi-textured draws for shifting the mask and producing the reordered image data.

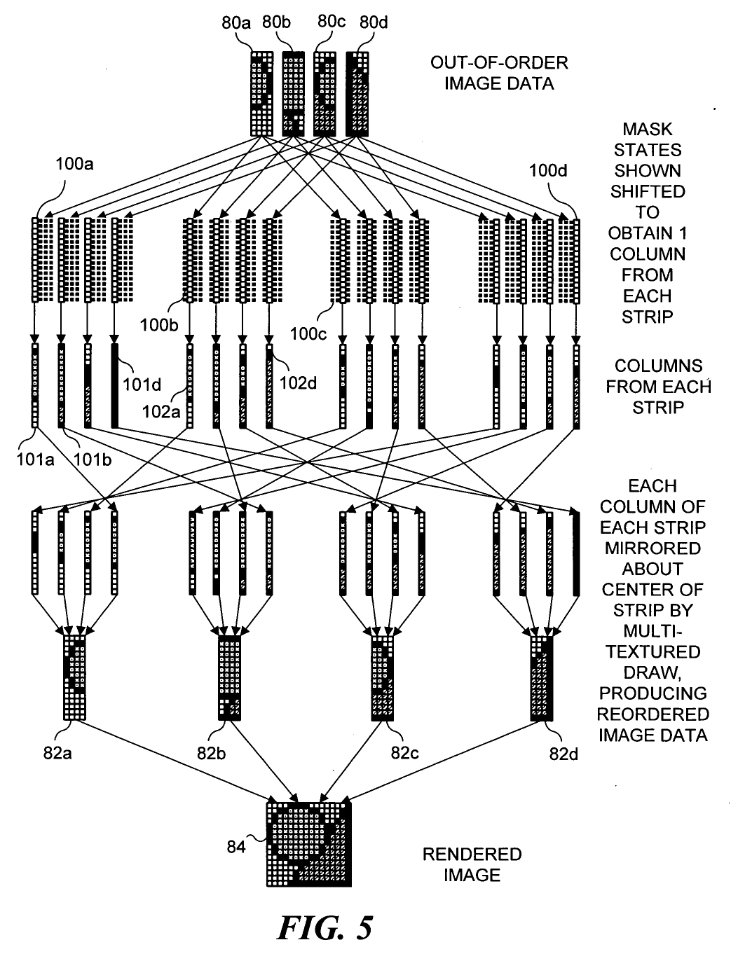

FIG. 5 is a graphical illustration of the steps described above for the second preferred embodiment. For easy comparison, the strips of out-of-order image data 80a through 80d are again used to illustrate the second preferred embodiment. Recall that strips 80a through 80d comprise 16-bit pixels (2 bytes per pixel), which result in four strips that are each four pixels wide. Accordingly, the mask is predefined as 4 pixels wide by 1 pixel tall. This initial configuration of the mask is illustrated by a first mask state 100a. In first mask state 100a, the left-most pixel is set to 1 (opaque) and the remaining three pixels are set to 0 (transparent). For purposes of illustrating this aspect of the invention, first mask state 100a is shown multiple times for each row of each strip of corresponding out-of-order image data. Preferably, the same 4 pixel mask is simply iteratively applied by the graphics hardware. As described above, the opaque pixel of the mask is also shifted during processing to select another column of out-of-order image data. A second mask state 100b illustrates how the opaque pixel is shifted by one pixel column. Similarly, a third pixel state 100c and a fourth pixel state 100d show the successive locations of the shifted opaque pixel. Again, the mask preferably only comprises 4 pixels, but is shown in FIG. 5 as iteratively applied to each row of each strip of out-of-order image data.

The mask is applied via multi-textured draws to produce individual columns of pixels from each strip. For example, applying first mask state 100a to strip 80a results in a left-most column 101a of strip 80a. Similarly, applying first mask state 100a to strips 80b through 80d results in corresponding left-most columns 101b through 101d, respectively. After shifting the opaque pixel, second mask state 100b is then applied to strips 80a through 80d to produce second columns 102a through 102d, respectively. This shifting and iterative application are continued throughout the multi-textured draw operations to produce individual columns of pixel data from each strip of the out-of-order image data.

The multi-textured draw operations also shift each column within a strip to its mirror opposite column position within the strip. The shifting of columns results from the multi-textured draw operations transforming the pixel data of each strip from source coordinates to destination positions after applying the mask in each of its states. Table 2 illustrates sample source coordinate, mask texture coordinates, and destination positions relative to the origin defined as the upper left corner of the emulator window area. The coordinates are again listed as top, left, bottom, and right.

TABLE 2
Sample Source Coordinates, Mask Texture Coordinates,
and Destination Positions

| | Mask Texture | |
|---|---|---|
| | Coordinates | |
| Source Coordinates | (top, left, | Destination Positions |
| (top, left, bottom, right) | bottom, right) | (top, left, bottom, right) |
| 0, 0, 16, 16 | 0, 0, 16, 16 | 0, 3, 16, 19 |
| 0, 0, 16, 16 | 0, 1, 16, 17 | 0, 1, 16, 17 |
| 0, 0, 16, 16 | 0, 2, 16, 18 | 0, −1, 16, 15 |
| 0, 0, 16, 16 | 0, 3, 16, 19 | 0, −3, 16, 13 |

The mirroring reorders the columns of pixel data from a pixilated little endian order to a big endian order, resulting in reordered strips 82a through 82d. The reordered image data of each strip are then displayed by the graphics hardware to produce rendered image 84.

Although the present invention has been described in connection with the preferred form of practicing it, those of ordinary skill in the art will understand that many modifications can be made thereto within the scope of the claims that follow. For example, programs other than emulation programs may generate and store out of order pixel data such as a video program. Accordingly, it is not intended that the scope of the invention in any way be limited by the above description, but instead be determined entirely by reference to the claims that follow.

1. A method for reordering data between a first predefined order and a second predefined order using a secondary processor to perform the reordering, thereby offloading the reordering of the data from a primary processor, the secondary processor reordering the data between the first predefined order and the second predefined order using an operation that was not provided for that purpose, the method comprising the steps of:
(a) enabling the secondary processor to access the data that are arranged in the first predefined order;
(b) determining subdivisions of the data that are arranged in the first predefined order, wherein each subdivision is based on a predefined size of each datum of the data;
(c) determining original positions of coordinates defining each subdivision within the data that are arranged in the first predefined order; and
(d) causing the secondary processor to perform the operation, which transforms the coordinates of each subdivision to new positions and repositions the data of each subdivision to have the same locations relative to the new positions as the data had relative to the original positions, thereby reordering the data from the first predefined order to the second predefined order.

2. The method of claim 1, wherein the secondary processor comprises a graphics processor.

3. The method of claim 1, wherein one of the following conditions exists:
(a) the first predefined order comprises a little endian order, and the second predefined order comprises a big endian order;
(b) the first predefined order comprises a big endian order and the second predefined order comprises a little endian order;
(c) the first predefined order comprises a pixilated little endian order, and the second predefined order comprises a big endian order; and
(d) the first predefined order comprises a pixilated big endian order, and the second predefined order comprises a little endian order.

4. The method of claim 1, wherein the data comprise image data.

5. The method of claim 1, wherein the operation comprises one of a draw operation and a multi-textured draw operation.

6. The method of claim 1, wherein the step of enabling the secondary processor to access the data comprises the steps of:
(a) predefining a secondary storage space that is accessible to the secondary processor;
(b) causing the primary processor to store the data in the first predefined order in a primary storage space that is accessible to both the primary processor and the secondary processor; and
(c) causing the secondary processor to copy the data in the first predefined order from the primary storage space to the secondary storage space.

7. The method of claim 1, wherein the step of determining the subdivisions comprises the steps of:
(a) determining a size of each subdivision as a function of the predefined size of each datum of the data; and
(b) determining a number of subdivisions within the data.

8. The method of claim 1, wherein the step of determining coordinates of each subdivision comprises the step of determining vertices of each subdivision relative to an origin of the data.

9. The method of claim 1, wherein the step of causing the secondary processor to perform the operation comprises the step of instructing the secondary processor to transpose the coordinates of each subdivision so as to mirror the data of each subdivision about a center position.

10. The method of claim 1, further comprising the steps of:
(a) predefining a mask for selectively retaining a subset of the data; and
(b) applying the mask to the subdivisions to further subdivide the data into a plurality of subsets of data that are iteratively repositioned to new locations relative to the new positions, the new locations corresponding to original locations relative to the original positions.

11. The method of claim 1, further comprising the step of determining a portion of data that changed since a previous execution cycle so that only the portion of data that changed since the previous execution cycle is reordered between the first predefined order and the second predefined order.

12. The method of claim 1, further comprising the step of displaying the data arranged in the second predefined order.

13. A memory medium on which are stored machine instructions for carrying out the steps of claim 1.

14. A system for reordering data between a first predefined order and a second predefined order using an operation not provided to the system for that purpose, comprising:
(a) a primary processor;
(b) a secondary processor in communication with the primary processor; and
(c) a memory in communication with the primary processor and the secondary processor, the memory storing the data in the first predefined order and storing machine instructions that cause the primary processor and the secondary processor to carry out a plurality of functions, including:
(i) accessing the data that are arranged in the first predefined order with the secondary processor;
(ii) using the primary processor, determining subdivisions of the data that are arranged in the first predefined order, wherein each subdivision is based on a predefined size of each datum of the data;
(iii) using the primary processor, determining original positions of coordinates defining each subdivision within the data that are arranged in the first predefined order; and
(iv) using the secondary processor for performing the operation, thereby transforming the coordinates of each subdivision to new positions and repositioning the data of each subdivision to have the same locations relative to the new positions as the data had relative to the original positions, thereby reordering the data from the first predefined order to the second predefined order.

15. The system of claim 14, wherein one of the following conditions exists:
(a) the first predefined order comprises a little endian order and the second predefined order comprises a big endian order;
(b) the first predefined order comprises a big endian order and the second predefined order comprises a little endian order;
(c) the first predefined order comprises a pixilated little endian order and the second predefined order comprises a big endian order; and
(d) the first predefined order comprises a pixilated big endian order and the second predefined order comprises a little endian order.

16. The system of claim 14, wherein the machine instructions further cause the primary processor to perform the functions of:
(a) determining a size of each subdivision as a function of the predefined size of each datum of the data; and
(b) determining a number of subdivisions within the data.

17. The system of claim 14, wherein the machine instructions further cause the primary processor to perform the function of determining vertices of each subdivision relative to an origin of the data.

18. The system of claim 14, wherein the machine instructions further cause the secondary processor to perform the function of transposing the coordinates of each subdivision so as to mirror the data of each subdivision about a center position.

19. The system of claim 14, wherein the machine instructions further cause the primary processor to perform the function of predefining a mask for selectively retaining a subset of the data and cause the secondary processor to perform the function of applying the mask to the subdivisions to further subdivide the data into a plurality of subsets of data that are iteratively repositioned to new locations relative to the new positions, the new locations corresponding to original locations relative to the original positions.

20. The system of claim 14, further comprising a display in communication with the secondary processor, wherein the machine instructions further cause the secondary processor to perform the function of displaying the data arranged in the second predefined order on the display.
